(19) United States
(12) Patent Application Publication
(10) Pub. No.: US 2015/0017871 A1
(43) Pub. Date: Jan. 15, 2015

(54) APPARATUS AND METHOD FOR RETAINING AND STORING A CHILD'S PACIFIER OR TEETHING-RING

(71) Applicant: Janet Noreen Deane, Edmonton (CA)

(72) Inventor: Janet Noreen Deane, Edmonton (CA)

(21) Appl. No.: 14/379,240

(22) PCT Filed: Feb. 15, 2013
(86) PCT No.: PCT/CA2013/000124

§ 371 Date: Aug. 15, 2014

Related U.S. Application Data
(60) Provisional application No. 61/600,031, filed on Feb. 17, 2012.

(51) Int. Cl. A61J 17/00; A61J 17/02

(52) U.S. Cl. CPC A61J 17/00; A61J 17/02; A61J 2017/001
USPC 446/227

(57) ABSTRACT

Apparatuses and methods for retaining and storing a child's pacifier or teething-ring are provided wherein a flexible pocket can store a pacifier/teething-ring when not in use and a tether can be used to retain the pacifier/teething-ring to child's clothing whether or not the pacifier/teething ring is in use. In some embodiments, the pocket can be formed in a caddy which can comprise, or can be retrofit to, a tether having a clothing fastening means at one end and a pacifier/teething-ring fastening means at the other, wherein the tether has sufficient length for the attached pacifier/teething-ring to be placed in the pocket, or in the child's mouth.

### CROSS REFERENCE TO RELATED APPLICATIONS

This application claims priority of U.S. provisional patent application Ser. No. 61/600,031 filed Feb. 17, 2012, and hereby incorporates the same provisional application by reference herein in its entirety.

### TECHNICAL FIELD

The present disclosure is related to the field of apparatuses and methods of retaining and storing a child's pacifier or teething-ring, in particular, apparatuses and methods of retaining and storing a child's pacifier or teething-ring using a tether.

### BACKGROUND

It is known that pacifiers, sometimes referred to as a dummy or a soother, are often spit out or dropped by a child using them. The pacifier can easily become unsanitary from landing on the ground or other dirty surfaces. Even when landing on clean fabrics, a pacifier can pick up lint and thread which is undesirable to insert into a child's mouth. As a result, the pacifier would need to be cleaned or replaced before it is reinserted into the child's mouth. In addition, the pacifier can be lost if a supervisor does not notice when the pacifier was dropped or spit out by a child. The same problems can also occur with teething rings.

It is also known to use a separate carrying case to keep a pacifier or teething ring clean and protected when not in use. These devices, however, cannot be tethered to a child and therefore, cannot be used while the child is using the pacifier or teething ring in their mouth, and can be almost as easy to lose as the pacifier/teething-ring itself.

Accordingly, there is a need to provide an apparatus and method for retaining and storing a child's pacifier/teething-ring that overcomes the shortcomings of the prior art.

### SUMMARY

Apparatuses and methods for retaining and storing a child's pacifier or teething-ring are provided wherein a flexible pocket can store a pacifier/teething-ring when not in use and a tether can be used to retain the pacifier/teething-ring to a child's clothing whether or not the pacifier/teething-ring is in use. In some embodiments, the pocket can be formed in a caddy which can comprise, or can be retrofit to, a tether, for example, a ribbon, having a clothing fastening means at one end and a pacifier/teething-ring fastening means at the other, wherein the tether has sufficient length for the attached pacifier/teething-ring to be placed in the pocket, or in the child's mouth. In some embodiments, the pocket can be disposed in the back part of the caddy and can be lined with a material, such as nylon, such that the pacifier/teething-ring can be placed inside of the pocket without causing lint or thread to attach to the pacifier/teething-ring. In some embodiments, the pacifier/teething-ring fastening means can comprise a loop tie that fastens the pacifier/teething-ring and the clothing fastening means can comprise a clip that can attach onto the child's clothing.

Broadly stated, in some embodiments, an apparatus is provided for retaining and storing a pacifier, the apparatus comprising: a caddy comprising a flexible pocket dimensioned to receive and hold the pacifier; a first tether portion extending from the caddy, the first tether portion terminating in a pacifier tie configured to attach to the pacifier; a second tether portion extending from the caddy in the opposite direction as the first tether portion, the second tether portion terminating in a fastener; wherein the caddy can be tethered to children's clothing by the fastener, the pacifier can be tethered to the caddy by the pacifier tie, and the pacifier can be removably stored in the pocket.

Broadly stated, in some embodiments, an apparatus is provided for storing a pacifier, the apparatus to be retrofit on a pacifier tether for retaining a pacifier, the apparatus comprising: a caddy comprising a flexible pocket dimensioned to receive and hold the pacifier; and an attachment surface configured to allow attachment to the tether.

Broadly stated, in some embodiments, a method is provided for retaining and storing a pacifier for a child, the method comprising the steps of: providing the apparatus as described herein; attaching the tether to the child; placing the pacifier in the pocket when the pacifier is not in use by the child; and removing the pacifier from the pocket when the pacifier is in use by the child.

Broadly stated, in some embodiments, an apparatus is provided for retaining and storing a teething-ring, the apparatus comprising: a caddy comprising a flexible pocket dimensioned to receive and hold the teething-ring; a first tether portion extending from the caddy, the first tether portion terminating in a tie configured to attach to the teething-ring; a second tether portion extending from the caddy in the opposite direction as the first tether portion, the second tether portion terminating in a fastener; wherein the caddy can be tethered to children's clothing by the fastener, the teething-ring can be tethered to the caddy by the tie, and the teething-ring can be removably stored in the pocket.

Broadly stated, in some embodiments, an apparatus for storing a teething-ring, the apparatus to be retrofit on a tether for retaining a teething-ring, the apparatus comprising: a caddy comprising a flexible pocket dimensioned to receive and hold the teething-ring; and an attachment surface configured to allow attachment to the tether.

Broadly stated, in some embodiments, a method is provided for retaining and storing a teething-ring for a child, the method comprising the steps of: providing the apparatus as described herein; attaching the tether to the child; placing the teething-ring in the pocket when the teething-ring is not in use by the child; and removing the teething-ring from the pocket when the teething-ring is in use by the child.

Broadly stated, in some embodiments, an apparatus is provided for retaining and storing a pacifier or teething-ring, the apparatus comprising: a caddy comprising a flexible pocket dimensioned to receive and hold the pacifier or teething-ring; a first tether portion reversibly attachable to the caddy, the first tether portion terminating in a tie configured to attach to the pacifier or teething-ring on one end and terminating in a fastener on the second end; a second tether portion extending from the caddy in the opposite direction as the first tether portion, the second tether portion terminating in an attachment means to reversibly attach to the first tether portion proximate the fastener; wherein the caddy can be tethered to children's clothing by the fastener, the pacifier or teething-ring can be tethered to the caddy by the tie, and the pacifier or teething-ring can be removably stored in the pocket.

Broadly stated, in some embodiments, an apparatus is provided for storing a pacifier or teething-ring, the apparatus to be retrofit on a tether for retaining a pacifier or teething-ring, the apparatus comprising: a caddy comprising a flexible pocket dimensioned to receive and hold the pacifier or teething-ring; and an attachment surface configured to allow attachment to the tether.

Broadly stated, in some embodiments, a method is provided for retaining and storing a pacifier or teething-ring for a child, the method comprising the steps of: providing the apparatus as described herein; attaching the caddy to the tether; attaching the tether to the child; placing the pacifier or teething-ring in the pocket when the pacifier or teething-ring is not in use by the child; and removing the pacifier or teething-ring from the pocket when the teething-ring is in use by the child.

### BRIEF DESCRIPTION OF THE DRAWINGS

FIG. 1A is a front elevation view depicting an embodiment of an apparatus for retaining and storing a child's pacifier.

FIG. 1B is a front elevation view depicting an embodiment of an apparatus for retaining and storing a child's teething-ring.

FIG. 2 is a perspective view depicting the apparatus of FIG. 1A.

FIG. 3 is a close-up, cut-off, perspective view depicting the pacifier end of the apparatus of FIG. 1A.

FIG. 4 is a close-up, cut-off, perspective view depicting the fastener end of the apparatus of FIG. 1A.

FIG. 5A is a close-up, cut-off, rear view depicting the pocket of the apparatus of FIG. 1A.

FIG. 5B is a close-up, cut-off, rear view depicting a further embodiment of an apparatus for retaining and storing a child's pacifier/teething-ring.

FIG. 5C is a close-up, cut-off, rear view depicting the apparatus of

FIG. 5B in a stored position.

FIG. 6 is a rear perspective view depicting the apparatus of FIG. 1A with the pacifier in a stored position.

FIG. 7 is a front perspective view depicting the apparatus of FIG. 1A with the pacifier in a stored position.

### DETAILED DESCRIPTION OF EMBODIMENTS

Apparatuses and methods for retaining and storing a pacifier or teething-ring are provided.

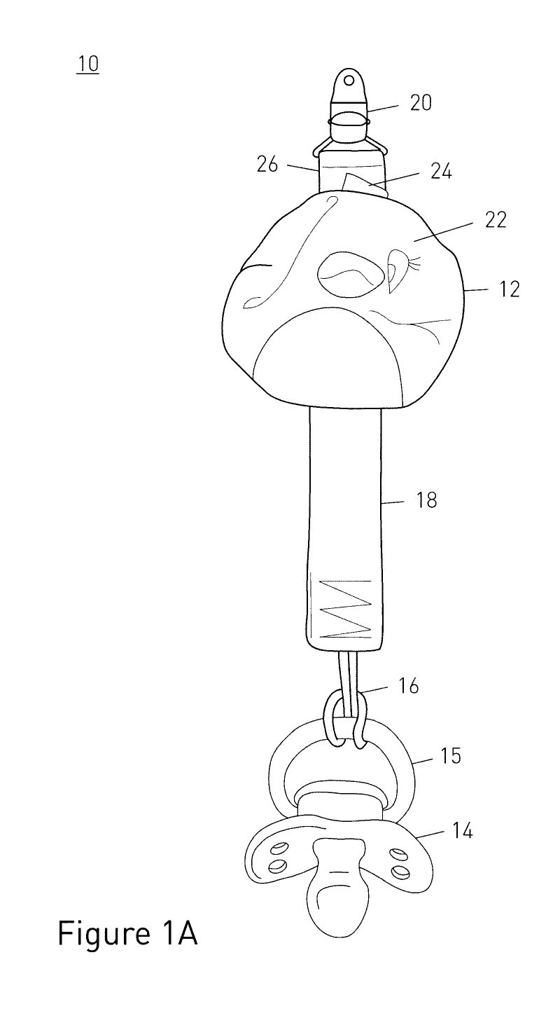

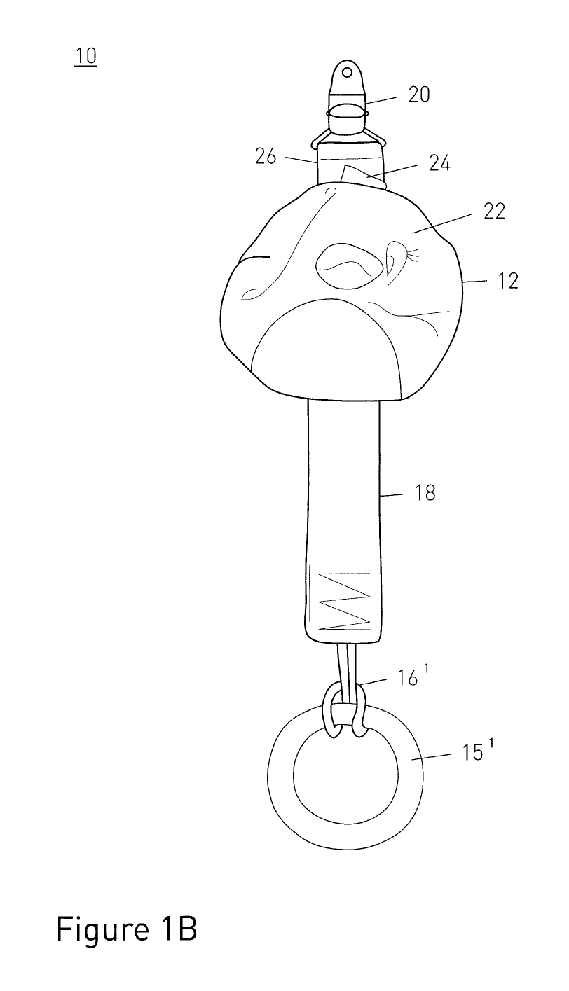

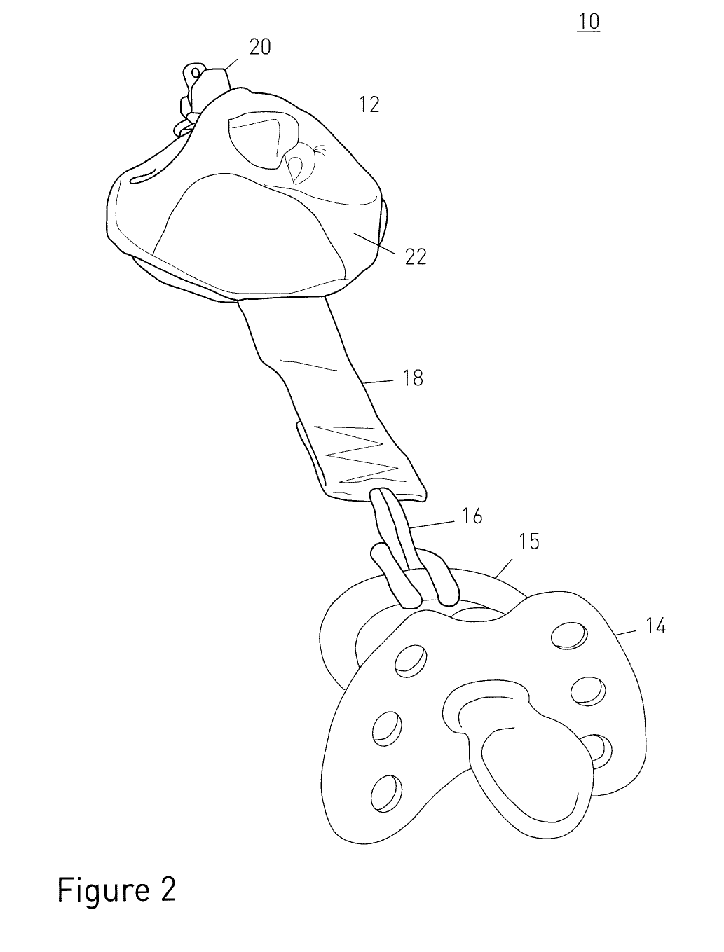

Referring to FIGS. 1A and 2, an embodiment of apparatus 10 is shown for retaining and storing a pacifier 14, for example in a caddy 12. The term pacifier can also refer to a soother or dummy as it can be known. Pacifier 14 can comprise pacifier ring 15 which can be attached to apparatus 10 by pacifier tie 16. Pacifier tie 16 can itself be attached to tether 18 which can connect to caddy 12. In some embodiments, apparatus 10 can further comprise fastener 20 connected to caddy 12 by upper tether portion 26.

Referring to FIG. 1B, an embodiment of apparatus 10 is shown for retaining and storing a teething-ring 15¹, for example in a caddy 12. The term teething-ring can also refer to a teether or other terms of art as it can be known. Teething-ring 15¹ can be attached to apparatus 10 by tie 16¹. Tie 16¹ can itself be attached to tether 18 which can connect to caddy 12. In some embodiments, apparatus 10 can further comprise fastener 20 connected to caddy 12 by upper tether portion 26.

Caddy 12 itself can be made of soft flexible material and can comprise a surface 22 on which to display a feature. The feature can be used to entertain the child to which apparatus is attached and can be, for example, a cartoon character, sports item or logo, flower, animal, vehicle, food item, basic shape, etc.

In some embodiments, caddy 12 can also comprise branding/care-instruction tag 24. Branding or instruction information can be printed onto tag 24 for the convenience of the owner.

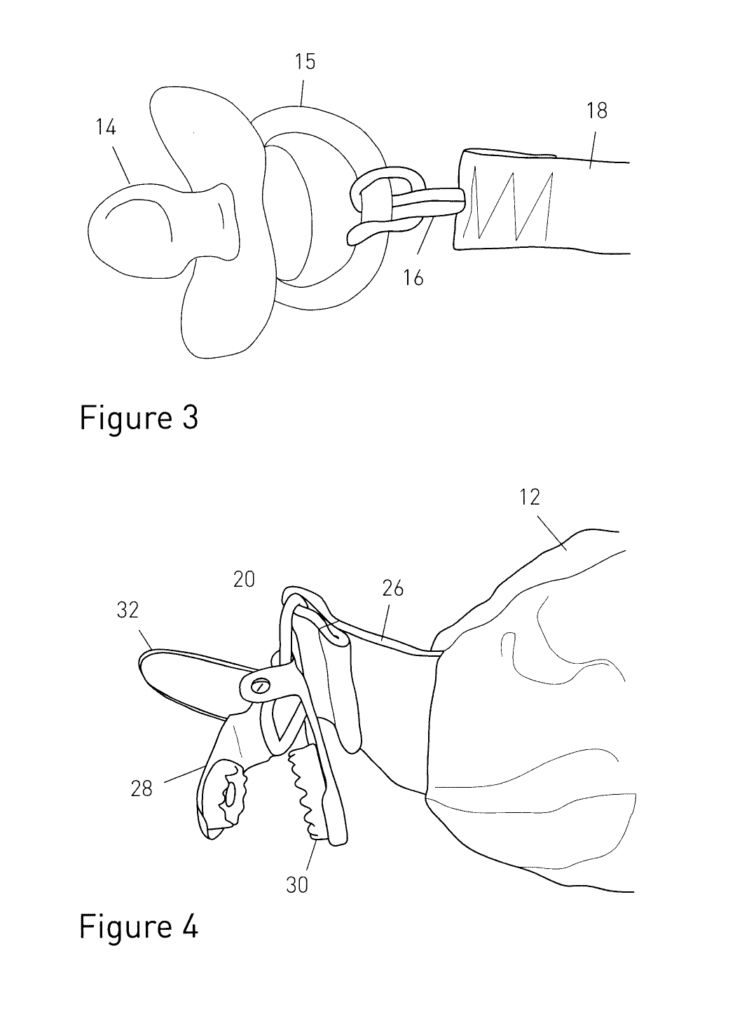

Referring now to FIG. 3, pacifier tie 16 can be seen up close. In some embodiments, pacifier tie 16 can comprise a loop of child friendly string-like material. Pacifier tie 16 can be sewn to the end of tether 18. As would be understood by one skilled in the art, pacifier tie 16 as a loop of string, can wrap around pacifier ring 15 and loop around itself in order to form a reversible knot which can retain pacifier 14 onto tether 18. Pacifier 14 can be detached from pacifier tie 16 and reattached for convenience when cleaning either pacifier 14 or apparatus 10 separately or swapping pacifier 14 or apparatus 10 for any other reason. As would be understood by one skilled in the art, any attachment means which can reversibly connect pacifier 14 to tether 18 could be used as pacifier tie 16, including VELCRO® brand hook and loop fasteners. The same can also be true for reversibly connecting teething-ring 15¹ to tether 18 by tie 16¹.

Referring now to FIG. 4, fastener 20 can be seen up close. In some embodiments, fastener 20 can be attached to upper tether portion 26, which in turn can be attached to caddy 12. In some embodiments, fastener 20 can comprise a clamp 28 as would be known by one skilled in the art. In other embodiments, any attachment means which can reversibly upper tether portion 26 to a child's clothing could be used as fastener 20, including VELCRO® brand hook and loop fasteners. Clamp 28 can further comprise teeth 30 as well as a lever 32 used to open and close clamp 28. In some embodiments, teeth 30 can be made of plastic so as not to present sharp edges on which the child may injure themselves. Fastener 20 can be used to fasten apparatus 10 to a child's clothing, for example, at the child's shoulder. Fastener 20 can act to retain apparatus 10 on the child's clothing so that apparatus 10 and pacifier 14 or teething-ring 15¹ do not become lost or dropped or dirty or soiled. Fastener 20 can then be disengaged from child's clothing for the purposes of washing apparatus 10 or for any other appropriate reason.

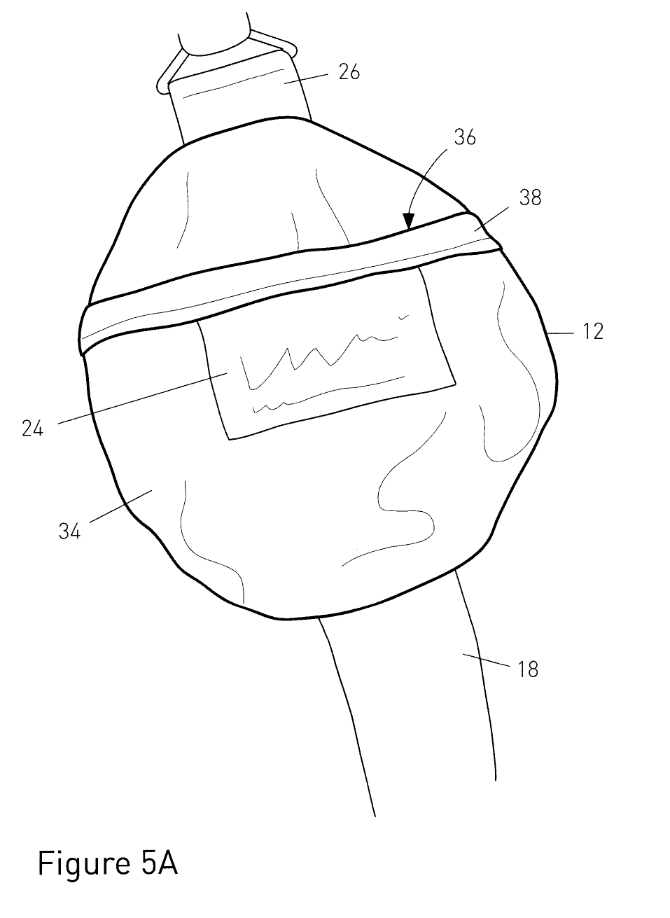

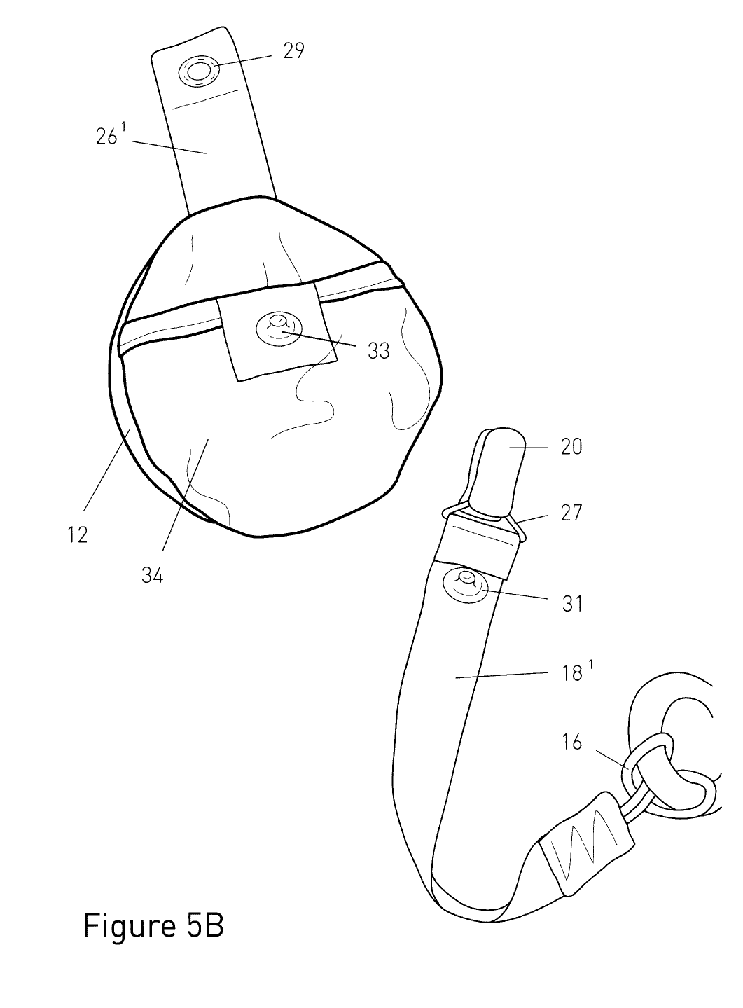

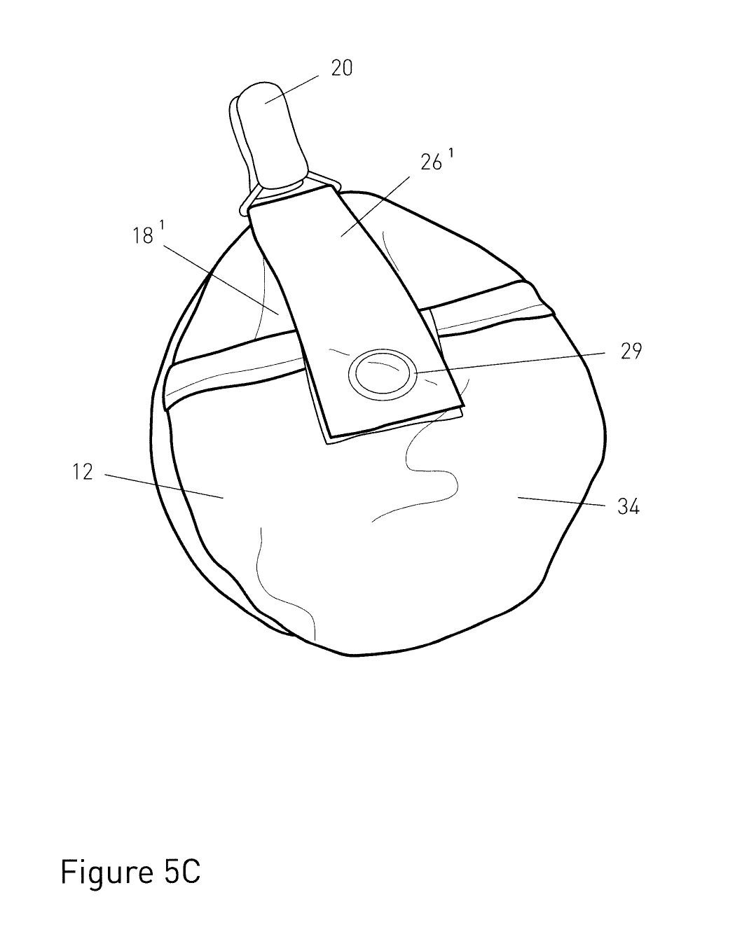

Referring now to FIG. 5A, an embodiment of caddy 12 can be seen from the rear which exposes back face 34 of caddy 12. Back face 34 can comprise branding/care-instruction tag 24, which can be, in some embodiments, approximately one and a half inches wide and approximately three-quarter inches high.

Back face 34 can further comprise pocket 36, which can be shaped and dimensioned to receive and hold pacifier 14 or teething-ring 15¹ through pocket opening 38. In some embodiments, caddy 12 can be approximately between three to four inches in diameter. In some embodiments, pocket opening 38 can open at approximately one inch from the top back of caddy 12 allowing for a pocket 36 depth of approximately two and a half inches and opening 38 can be approximately three inches wide. The edge of pocket opening 38 can also be reinforced by a ribbing of smooth, lint-free, material to provide strength and allow for pacifier 14 to enter pocket 36 smoothly. In some embodiments, pocket 36 and pocket opening 38 could be disposed on the front face of caddy 12. In some embodiments, pocket 38 can be reinforced by additional material to prevent wear and tear. Back face 34 and pocket 36 can be made of an easy to clean, non-stick material such as nylon, so that a wet pacifier 14 or teething ring 15¹ does not pick up material lint or other dirt from caddy 12.

Referring now to FIGS. 5B and 5C, an embodiment of caddy 12 can be seen from the rear which exposes back face 34 of pacifier caddy 12. In some embodiments, back face 34 can comprise upper tether portion 26¹ which can be fed through eyelet 27 of fastener 20 and reversibly connect to removable tether 18¹ by a fastening means, such as snap button 29 to snap button 31. As shown in FIG. 5C, snap button 29 can also reversibly connect to snap button 33 on back face 34 while storing to removable tether 18¹ (with or without pacifier 14 or teething ring 15¹) in pocket 36. In other embodiments, any fastening means which can reversibly upper tether portion 26¹ to removable tether 18¹ or back face 34 could be used in addition to, or in place of, snap buttons 29, 31, and/or 33, including traditional buttons, reversible adhesives, VELCRO® brand hook and loop fasteners, or any other appropriate fasteners.

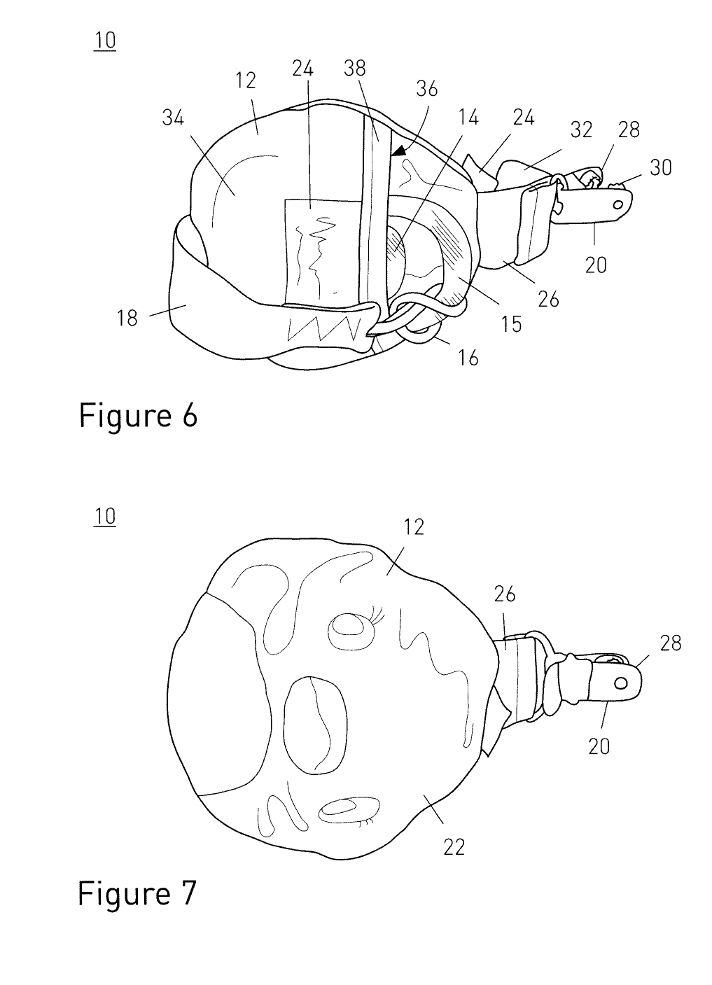

Referring now to FIG. 6, apparatus 10 can be shown in operation where pacifier tie 16 is attached to pacifier ring 15 and pacifier 14 has been placed and stored inside pocket 36 through pocket opening 38. When in operation, fastener 20 can remain attached to child's clothing and pacifier 14 will be protected by pacifier caddy 12 from becoming soiled, tangled, cold, otherwise damaged or lost. Attachment of fastener 20 to child's clothing and the proximity of caddy 12 to the child's mouth can also facilitate the child obtaining pacifier 14 for use.

Referring now to FIG. 7, apparatus 10 is shown from the front view in which pacifier 14 or teething-ring 15¹ can be stored in caddy 12. Again, fastener 20 can be used to attach apparatus 10 to child's clothing with surface 22 for design features being exposed to the child and the public.

Tether 18 or 18¹ can be of appropriate length such that it can bend to allow pacifier 14 or teething-ring 15¹ to be positioned through pocket opening 38 and to pocket 36, for example approximately four inches in some embodiments. Tether 18 or 18¹ and upper tether portion 26 or 26¹ can be made up of flexible material to allow for pacifier 14 or teething-ring 15¹ to be placed in the child's mouth and into caddy 12 when fastener 20 is attached to child's clothes. In some embodiments, the combined length tether 18 or 18¹ and upper tether portion 26 or 26¹ can be approximately seven and a half inches long between tie 16 or 16¹ and fastener 20. In some embodiments, additional length of tether 18 or 18¹ and upper tether portion 26 or 26¹ can be used in manufacturing to fold over, and be sewn to itself in order to attach tie 16 or 16¹ or fastener 20.

Some embodiments of caddy 12 can be used to be retro fit onto existing pacifier tethering devices. The function of storing and protecting pacifier 14 or teething-ring 15¹ can be achieved by the addition of caddy 12 to an existing tether which does not have storage or protection functions. In some embodiments (not shown), caddy 12 can have an opening from the top to the bottom so that at least one end of a tether can pass through, or any other means of attaching a tether to caddy 12, leaving pocket 36 accessible, as would be apparent to one skilled in the art, for example, using attachment surfaces such as snaps, buttons, VELCRO® brand hook and loop fasteners, or any other appropriate fasteners.

In some embodiments, fastener 20 can be used to reversibly attach caddy 12 in a position other than a child's clothing in order to store or transport apparatus 10 (with or without pacifier 14 or teething-ring 15¹), for example on a parent's clothing, a diaper bag or back-pack, a stroller, or other similar places.

In order to provide child safety, components of apparatus 10 can be free of unsafe chemicals and lead (and other dangerous heavy metals), and stand up to mechanical strength tests and flammability tests.

Although a few embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

1. An apparatus for retaining and storing a pacifier, the apparatus comprising:
a caddy comprising a flexible pocket dimensioned to receive and hold the pacifier;
a first tether portion extending from the caddy, the first tether portion terminating in a pacifier tie configured to attach to the pacifier;
a second tether portion extending from the caddy in the opposite direction as the first tether portion, the second tether portion terminating in a fastener; wherein the caddy can be tethered to children's clothing by the fastener, the pacifier can be tethered to the caddy by the pacifier tie, and the pacifier can be removably stored in the pocket.

2. The apparatus as claimed in claim 1 where the pocket is made of nylon.

3. The apparatus as claimed in claim 1 wherein the pocket is disposed on a back surface of the pacifier caddy.

4. The apparatus as claimed in claim 1, wherein caddy comprises a front surface for a feature.

5. The apparatus as claimed in claim 1, wherein the pacifier tie comprises a loop of child safe string material.

6. The apparatus as claimed in claim 1, wherein the fastener comprises a clamp.

7. The apparatus as claimed in claim 1, wherein the distance between the pacifier tie and the clothing fastener is approximately 7.5 inches.

8. An apparatus for storing a pacifier, the apparatus to be retrofit on a pacifier tether for retaining a pacifier, the apparatus comprising:
a caddy comprising a flexible pocket dimensioned to receive and hold the pacifier; and
an attachment surface configured to allow attachment to the tether.

9. The apparatus as claimed in claim 8, where the pocket is made of nylon.

10. The apparatus as claimed in claim 8, wherein the pocket is disposed on a back surface of the caddy.

11. The apparatus as claimed in claim 8, wherein the caddy comprises a front surface for a feature.

12. The apparatus as claimed in claim 8, wherein the caddy is attached by the attachment surfaces to the tether providing a distance between the pacifier caddy and the pacifier end of the tether is approximately 4 inches.

13. A method of retaining and storing a pacifier for a child, the method comprising the steps of:
providing
a caddy comprising a flexible pocket dimensioned to receive and hold the pacifier;
a first tether portion extending from the caddy, the first tether portion terminating in a pacifier tie configured to attach to the pacifier;
a second tether portion extending from the caddy in the opposite direction as the first tether portion, the second tether portion terminating in a fastener; wherein the caddy can be tethered to children's clothing by the fastener, the pacifier can be tethered to the caddy by the pacifier tie, and the pacifier can be removably stored in the pocket
attaching the tether to the child;
placing the pacifier in the pocket when the pacifier is not in use by the child; and
removing the pacifier from the pocket when the pacifier is in use by the child.

14. An apparatus for retaining and storing a teething-ring, the apparatus comprising:
a caddy comprising a flexible pocket dimensioned to receive and hold the teething-ring;
a first tether portion extending from the caddy, the first tether portion terminating in a tie configured to attach to the teething-ring;
a second tether portion extending from the caddy in the opposite direction as the first tether portion, the second tether portion terminating in a fastener; wherein the caddy can be tethered to children's clothing by the fastener, the teething-ring can be tethered to the caddy by the tie, and the teething-ring can be removably stored in the pocket.

15. (canceled)

16. (canceled)

17. An apparatus for retaining and storing a pacifier or teething-ring, the apparatus comprising:
a caddy comprising a flexible pocket dimensioned to receive and hold the pacifier or teething-ring;
a first tether portion reversibly attachable to the caddy, the first tether portion terminating in a tie configured to attach to the pacifier or teething-ring on one end and terminating in a fastener on the second end;
a second tether portion extending from the caddy in the opposite direction as the first tether portion, the second tether portion terminating in an attachment means to reversibly attach to the first tether portion proximate the fastener;
wherein the caddy can be tethered to children's clothing by the fastener, the pacifier or teething-ring can be tethered to the caddy by the tie, and the pacifier or teething-ring can be removably stored in the pocket.

18. (canceled)

19. (canceled)

20. (canceled)
